(19) United States
(12) Patent Application Publication
(10) Pub. No.: US 2023/0395302 A1
(43) Pub. Date: Dec. 7, 2023

(54) WOUND CORE

(71) Applicant: NIPPON STEEL CORPORATION, Tokyo (JP)

(72) Inventor: Takahito MIZUMURA, Tokyo (JP)

(73) Assignee: NIPPON STEEL CORPORATION, Tokyo (JP)

(21) Appl. No.: 18/033,112

(22) PCT Filed: Oct. 26, 2021
(86) PCT No.: PCT/JP2021/039548

§ 371 Date: Apr. 21, 2023

(30) Foreign Application Priority Data
Oct. 26, 2020 (JP) 2020-179267

(51) Int. Cl. H01F 27/245; C22C 38/02

(52) U.S. Cl. CPC H01F 27/2455; C22C 38/02

(57) ABSTRACT

This wound core is a wound core including a wound core main body obtained by stacking a plurality of polygonal annular grain-oriented electrical steel sheets in a side view, and the grain-oriented electrical steel sheet has planar portions and bent portions that are alternately continuous in a longitudinal direction, and in a planar portion in the vicinity of at least one bent portion, when the three-dimensional crystal orientation difference between two adjacent points in a series of points arranged at equal intervals in the extension direction of the bent portion is φ, a total number of measured data items of φ is Nx, the number of data items that satisfy φ≥1.0° is Nt, the number of data items that satisfy φ of 1.0° or more and less than 2.5° is Na, the number of data items that satisfy φ of 2.5° or more and less than 4.0° is Nb, and the number of data items that satisfy φ of 4.0° or more is Nc, the following formulae (1) to (4) are satisfied:

0.10≤Nt/Nx≤0.80 (1)

0.37≤Nb/Nt≤0.80 (2)

1.07≤Nb/Na≤4.00 (3)

Nb/Nc≥1.10 (4)

### TECHNICAL FIELD

The present invention relates to a wound core. Priority is claimed on Japanese Patent Application No. 2020-179267, filed Oct. 26, 2020, the content of which is incorporated herein by reference.

### BACKGROUND ART

The grain-oriented electrical steel sheet is a steel sheet containing 7 mass % or less of Si and has a secondary recrystallization texture in which secondary recrystallization grains are concentrated in the {110}<001>orientation (Goss orientation). The magnetic properties of the grain-oriented electrical steel sheet greatly influence the degree of concentration in the {110}<001>orientation. In recent years, grain-oriented electrical steel sheets that have been put into practical use are controlled so that the angle between the crystal <001>direction and the rolling direction is within a range of about 5°.

Grain-oriented electrical steel sheets are laminated and used in iron cores of transformers, and as their main magnetic properties such as a high magnetic flux density and a low iron loss are required. It is known that the crystal orientation has a strong correlation with these properties. For example, Patent Documents 1 to 3 discloses a precise orientation control technique in which the deviation between the actual crystal orientation and the ideal {110}<001>orientation of the grain-oriented electrical steel sheet is divided into a deviation angle α around a rolling surface normal direction, a deviation angle β around a direction perpendicular to the rolling direction, and a deviation angle γ around a rolling direction.

In addition, in the related art, for wound core production, as described in, for example, Patent Document 4, a method of winding a steel sheet into a cylindrical shape, then pressing the cylindrical laminated body without change so that the corner portion has a constant curvature, forming it into a substantially rectangular shape, then performing annealing to remove strain, and maintaining the shape is widely known.

On the other hand, as another method of producing a wound core, techniques such as those found in Patent Documents 5 to 7 in which portions of steel sheets that become corner portions of a wound core are bent in advance so that a relatively small bent area with a radius of curvature of 3 mm or less is formed and the bent steel sheets are laminated to form a wound core are disclosed. According to this production method, a conventional large-scale pressing process is not required, the steel sheet is precisely bent to maintain the shape of the iron core, and processing strain is concentrated only in the bent portion (corner) so that it is possible to omit strain removal according to the above annealing process, and its industrial advantages are great and its application is progressing.

### CITATION LIST

### Patent Document

### [Patent Document 1]

Japanese Unexamined Patent Application, First Publication No. 2001-192785

### [Patent Document 2]

Japanese Unexamined Patent Application, First Publication No. 2005-240079

### [Patent Document 3]

Japanese Unexamined Patent Application, First Publication No. 2012-052229

### [Patent Document 4]

Japanese Unexamined Patent Application, First Publication No. 2005-286169

### [Patent Document 5]

Japanese Patent No. 6224468

### [Patent Document 6]

Japanese Unexamined Patent Application, First Publication No. 2018-148036

### [Patent Document 7]

Australian Patent Application Publication No. 2012337260

### SUMMARY OF THE INVENTION

### Problems to be Solved by the Invention

An object of the present invention is to provide a wound core produced by a method of bending steel sheets in advance so that a relatively small bent area having a radius of curvature of 5 mm or less is formed and laminating the bent steel sheets to form a wound core, and the wound core is improved so that deterioration of iron core efficiency due to bending is minimized.

### Means for Solving the Problem

The inventors studied details of efficiency of a transformer iron core produced by a method of bending steel sheets in advance so that a relatively small bent area having a radius of curvature of 5 mm or less is formed and laminating the bent steel sheets to form a wound core. As a result, they recognized that, even if steel sheets with substantially the same crystal orientation control and substantially the same magnetic flux density and iron loss measured with a single sheet are used as a material, there is a difference in iron core efficiency.

After investigating the cause, it was speculated that the difference in efficiency that is a problem is caused by the difference in the degree of iron loss deterioration during bending for each material.

In this regard, various steel sheet production conditions and iron core shapes were studied, and the influences on iron core efficiency were classified. As a result, the result in which steel sheets produced under specific production conditions are used as iron core materials having specific sizes and shapes, and thus the iron core efficiency can be controlled so that it becomes optimal efficiency according to magnetic properties of the steel sheet material was obtained.

The present invention has been made in view of the above circumstances, and the gist thereof is as follows.

A wound core according to one embodiment of the present invention is a wound core including a substantially polygonal wound core main body in a side view,
wherein the wound core main body includes a portion in which grain-oriented electrical steel sheets in which planar portions and bent portions are alternately continuous in a longitudinal direction are stacked in a sheet thickness direction and has a substantially polygonal laminated structure in a side view,
wherein the bent portion in a side view has an inner radius of curvature r of 1 mm or more and 5 mm or less,
wherein the grain-oriented electrical steel sheet has a chemical composition containing,
in mass %,
Si: 2.0 to 7.0%, with the remainder being Fe and impurities, and
has a texture oriented in the Goss orientation,
wherein, in one or more of the planar portions adjacent to at least one of the bent portions, the following formulae (1) to (4) are satisfied:

0.10≤Nt/Nx≤0.80 (1)

0.37≤Nb/Nt≤0.80 (2)

1.07≤Nb/Na≤4.00 (3)

Nb/Nc≥1.10 (4)

Here, in a region of the planar portion adjacent to the bent portion, when a plurality of measurement points are arranged at intervals of 5 mm in a direction parallel to a bent portion boundary which is a boundary between the bent portion and the planar portion, Nx in Formula (1) is a total number of grain boundary determination points present in the center of two measurement points adjacent in the parallel direction and for determining whether there is a grain boundary between the two measurement points.

In addition, regarding a crystal orientation observed in the grain-oriented electrical steel sheet,
when a deviation angle from an ideal Goss orientation with a rolling surface normal direction Z as a rotation axis is defined as α,
a deviation angle from an ideal Goss orientation with a direction perpendicular to the rolling direction C as a rotation axis is defined as β, and
a deviation angle from an ideal Goss orientation with a rolling direction L as a rotation axis is defined as γ,
if the deviation angles of the crystal orientation measured at the two measurement points are expressed as (α₁ β₁ γ₁) and (α₂ β₂γ₂), when a three-dimensional orientation difference of the deviation angle α, the deviation angle β, and the deviation angle γ is defined as an angle φ_{3D} obtained by the following Formula (6),
Nt in Formulae (1) and (2) is the number of grain boundary determination points that satisfy φ_{3D}≥1.0°,
Na in Formula (3) is the number of grain boundary determination points that satisfy φ_{3D} of 1.0° or more and less than 2.5°,
Nb in Formulae (2) and (3) is the number of grain boundary determination points that satisfy φ_{3D} of 2.5° or more and less than 4.0°, and
Nc in Formula (4) is the number of grain boundary determination points in which φ_{3D} is 4.0° or more,

φ_{3D}=[(α₂−α₁)²+(β₂−β₁)²+(γ₂−γ₁)²]^{1/2} (6)

In addition, in the configuration of one embodiment of the present invention, in the planar portion adjacent to at least one of the bent portions, the following Formula (5) may be satisfied.

φ_{3D}ave:2.0° to 4.0° (5)

Here, φ_{3D}ave is an average value of φ_{3D} at grain boundary determination points that satisfy φ_{3D}≥1.0°.

### Effects of the Invention

According to the present invention, in the wound core formed by laminating bent steel sheets, it is possible to effectively minimize deterioration of iron core efficiency due to bending.

### BRIEF DESCRIPTION OF DRAWINGS

FIG. 1 is a perspective view schematically showing a wound core according to one embodiment of the present invention.

FIG. 2 is a side view of the wound core shown in the embodiment of FIG. 1.

FIG. 3 is a side view schematically showing a wound core according to another embodiment of the present invention.

FIG. 4 is a side view schematically showing an example of a single-layer grain-oriented electrical steel sheet constituting a wound core according to the present invention.

FIG. 5 is a side view schematically showing another example of a single-layer grain-oriented electrical steel sheet constituting the wound core according to the present invention.

FIG. 6 is a side view schematically showing an example of a bent portion of a grain-oriented electrical steel sheet constituting the wound core according to the present invention.

FIG. 7 is a diagram schematically illustrating a deviation angle related to crystal orientation observed in a grain-oriented electrical steel sheet.

FIG. 8 is a schematic view illustrating a method of arranging a plurality of measurement points in a planar portion region adjacent to a bent portion and determining grain boundary points for two adjacent measurement points.

FIG. 9 is a schematic view showing size parameters of wound cores produced in examples and comparative examples.

### EMBODIMENT(S) FOR IMPLEMENTING THE INVENTION

Hereinafter, a wound core according to one embodiment of the present invention will be described in detail in order. However, the present invention is not limited to only the configuration disclosed in the present embodiment, and can be variously modified without departing from the gist of the present invention. Here, lower limit values and upper limit values are included in the numerical value limiting ranges described below. Numerical values indicated by “more than” or “less than” are not included in these numerical value ranges. In addition, unless otherwise specified, “%” relating to the chemical composition means “mass %.”

In addition, terms such as “parallel,” “perpendicular,” “identical,” and “right angle” and length and angle values used in this specification to specify shapes, geometric conditions and their extents are not bound by strict meanings, and should be interpreted to include the extent to which similar functions can be expected.

In addition, in this specification, “grain-oriented electrical steel sheet” may be simply described as “steel sheet” or “electrical steel sheet” and “wound core” may be simply described as “iron core.”

A wound core according to the present embodiment is a wound core including a substantially polygonal wound core main body in a side view,
wherein the wound core main body includes a portion in which grain-oriented electrical steel sheets in which planar portions and bent portions are alternately continuous in a longitudinal direction are stacked in a sheet thickness direction and has a substantially polygonal laminated structure in a side view,
wherein the bent portion in a side view has an inner radius of curvature r of 1 mm or more and 5 mm or less,
wherein the grain-oriented electrical steel sheet has a chemical composition containing, in mass %, Si: 2.0 to 7.0%, with the remainder being Fe and impurities, and has a texture oriented in the Goss orientation, and in one or more of the planar portions adjacent to at least one of the bent portions, the following formulae (1) to (4) are satisfied:

0.10≤Nt/Nx≤0.80 (1)

0.37≤Nb/Nt≤0.80 (2)

1.07≤Nb/Na≤4.00 (3)

Nb/Nc≥1.10 (4)
where, in a region of the planar portion adjacent to the bent portion, when a plurality of measurement points are arranged at intervals of 5 mm in a direction parallel to a bent portion boundary which is a boundary between the bent portion and the planar portion, Nx in Formula (1) is a total number of grain boundary determination points present in the center of two measurement points adjacent in the parallel direction and for determining whether there is a grain boundary between the two measurement points,
in addition, regarding a crystal orientation observed in the grain-oriented electrical steel sheet,
when a deviation angle from an ideal Goss orientation with a rolling surface normal direction Z as a rotation axis is defined as α,
a deviation angle from an ideal Goss orientation with a direction perpendicular to the rolling direction C as a rotation axis is defined as β, and
a deviation angle from an ideal Goss orientation with a rolling direction L as a rotation axis is defined as γ,
if the deviation angles of the crystal orientation measured at the two measurement points are expressed as (α₁ β₁ γ₁) and (α₂ β₂γ₂), when a three-dimensional orientation difference of the deviation angle α, the deviation angle β, and the deviation angle γ is defined as an angle φ_{3D} obtained by the following Formula (6),
Nt in Formulae (1) and (2) is the number of grain boundary determination points that satisfy φ_{3D}≥1.0°,
Na in Formula (3) is the number of grain boundary determination points that satisfy φ_{3D} of 1.0° or more and less than 2.5°,
Nb in Formulae (2) and (3) is the number of grain boundary determination points that satisfy φ_{3D} of 2.5° or more and less than 4.0°, and
Nc in Formula (4) is the number of grain boundary determination points in which φ_{3D} is 4.0° or more.

φ_{3D}=[(α₂−α₁)²+(β₂−β₁)²+(γ₂−γ₁)²]^{1/2} (6)

### 1. Shape of Wound Core and Grain-Oriented Electrical Steel Sheet

First, the shape of a wound core of the present embodiment will be described. The shapes themselves of the wound core and the grain-oriented electrical steel sheet described here are not particularly new. For example, they merely correspond to the shapes of known wound cores and grain-oriented electrical steel sheets introduced in Patent Documents 5 to 7 in the related art.

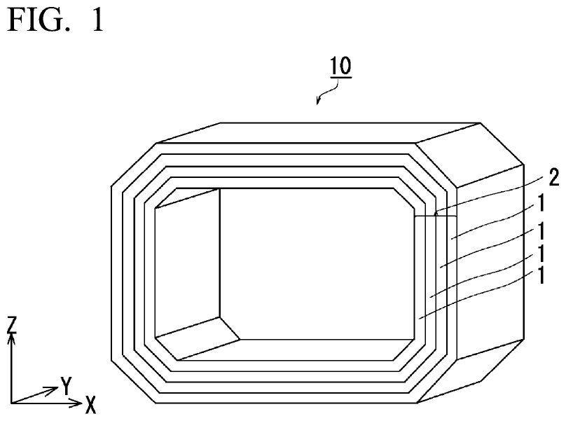

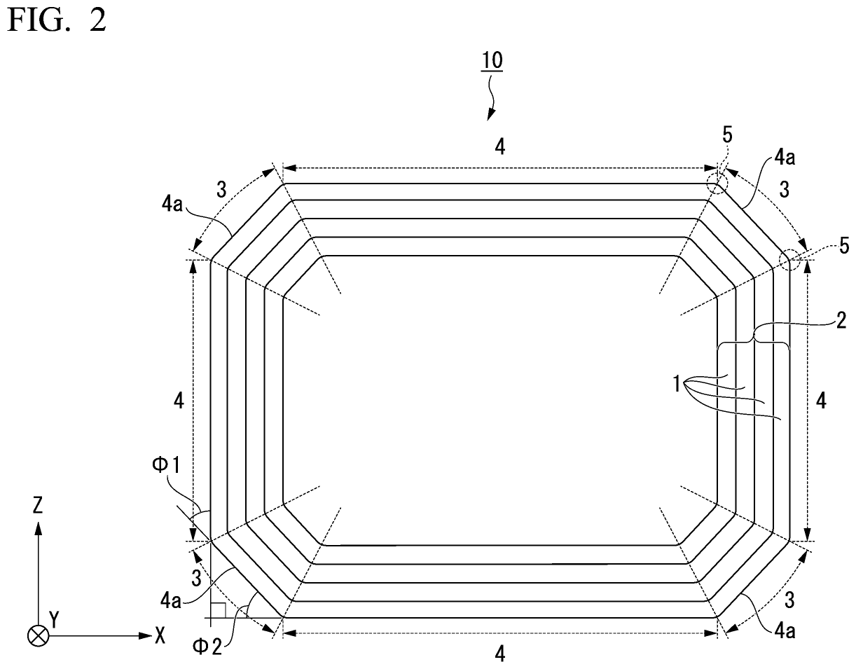

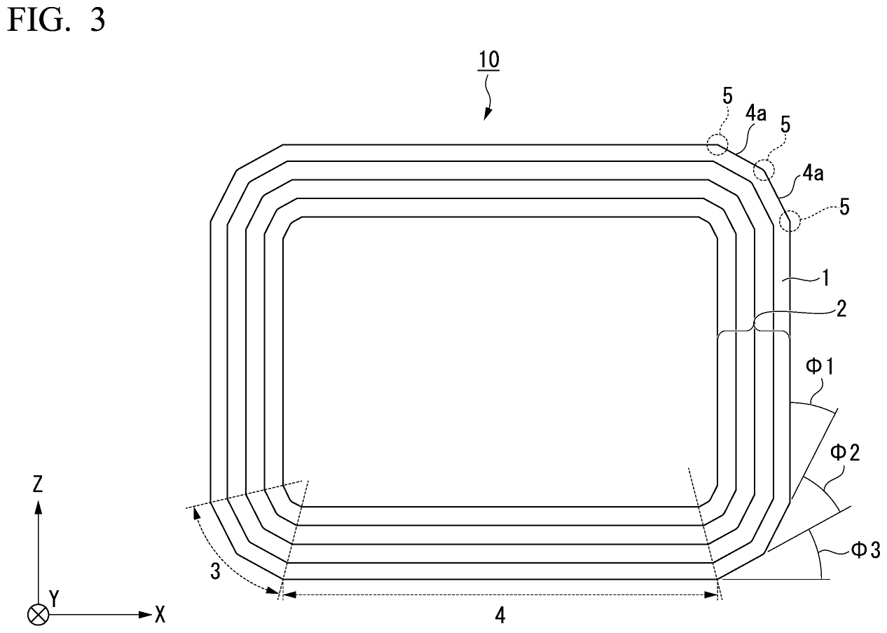

FIG. 1 is a perspective view schematically showing a wound core according to one embodiment. FIG. 2 is a side view of the wound core shown in the embodiment of FIG. 1. In addition, FIG. 3 is a side view schematically showing another embodiment of the wound core.

Here, in the present embodiment, the side view is a view of the long-shaped grain-oriented electrical steel sheet constituting the wound core in the width direction (Y-axis direction in FIG. 1). The side view is a view showing a shape visible from the side (a view in the Y-axis direction in FIG. 1).

The wound core according to the present embodiment includes a substantially polygonal (substantially rectangular) wound core main body 10 in a side view. The wound core main body 10 has a substantially rectangular laminated structure 2 in a side view in which grain-oriented electrical steel sheets 1 are stacked in a sheet thickness direction. The wound core main body 10 may be used as a wound core without change or may include, as necessary, for example, a known fastener such as a binding band for integrally fixing the stacked plurality of grain-oriented electrical steel sheets 1.

In the present embodiment, the iron core length of the wound core main body 10 is not particularly limited. Even if the iron core length of the iron core changes, the volume of a bent portion 5 is constant so that the iron loss generated in the bent portion 5 is constant. If the iron core length is longer, the volume ratio of the bent portion 5 to the wound core main body 10 is smaller and the influence on iron loss deterioration is also small. Therefore, a longer iron core length of the wound core main body 10 is preferable. The iron core length of the wound core main body 10 is preferably 1.5 m or more and more preferably 1.7 m or more. Here, in the present embodiment, the iron core length of the wound core main body 10 is the circumferential length at the central point in the laminating direction of the wound core main body 10 in a side view.

The wound core of the present embodiment can be suitably used for any conventionally known application.

The iron core of the present embodiment has substantially a polygonal shape in a side view. In the description using the following drawings, for simplicity of illustration and explanation, a substantially rectangular (square) iron core, which is a general shape, will be described, but the angles and number of bent portions and the length of the planar portion may be appropriately changed, and thereby iron cores having various shapes can be produced. For example, if the angles of all the bent portions are 45° and the lengths of the planar portions are equal, the side view is octagonal. In addition, if the angle is 60°, there are six bent portions, and the lengths of the planar portions are equal, the side view is hexagonal.

As shown in FIG. 1 and FIG. 2, the wound core main body 10 includes a portion in which the grain-oriented electrical steel sheets 1 in which planar portions 4 and bent portions 5 are alternately continuous in a longitudinal direction are stacked in a sheet thickness direction, and has a substantially rectangular laminated structure 2 in a side view. In a side view of the wound core main body 10, the planar portions 4 include two types, four planar portions 4a whose length in the circumferential direction of the wound core main body 10 is longer than a planar portion 4b and four planar portions 4b whose length in the circumferential direction of the wound core main body 10 is shorter than the planar portion 4a. However, the planar portion 4a and the planar portion 4b may have the same length.

In addition, in the wound core main body 10 shown in FIG. 3, in a side view of the wound core main body 10, the planar portions 4 include two types, four planar portions 4a whose length in the circumferential direction of the wound core main body 10 is long and eight planar portions 4b whose length in the circumferential direction of the wound core main body 10 is short.

In the embodiment of FIG. 2, one bent portion 5 has an angle of 45°. In the embodiment of FIG. 3, one bent portion 5 has an angle of 30°. That is, in any embodiment, the sum of the bent angles of respective bent portions present in one corner portion 3 is 90°.

In addition, the wound core main body 10 includes four corner portions 3. Each corner portion 3 of the wound core main body 10 shown in FIG. 2 includes one planar portion 4b and two bent portions 5 connected to both ends thereof. Each corner portion 3 of the wound core main body 10 shown in FIG. 3 includes two adjacent planar portions 4b and 4b, the bent portion 5 provided between the planar portions 4b and 4b and connected to the planar portions 4b and 4b, and the bent portion 5 connected to ends of the two planar portions 4b and 4b. That is, the embodiment of FIG. 2 includes two bent portions 5 in one corner portion 3. The embodiment of FIG. 3 includes three bent portions 5 in one corner portion 3.

Here, in the following description, both the planar portion 4a and the planar portion 4b will be described as the planar portion 4.

As shown in these examples, the iron core of the present embodiment can be formed with bent portions having various angles. In order to minimize the occurrence of distortion due to deformation during processing and minimize the iron loss, the bent angle φ (φ1, φ2, φ3) of the bent portion 5 is preferably 60° or less and more preferably 45° or less.

The bent angle φ of the bent portion of one iron core can be arbitrarily formed. For example, φ1=60° and φ2=30° can be set, but it is preferable that folding angles be equal in consideration of production efficiency.

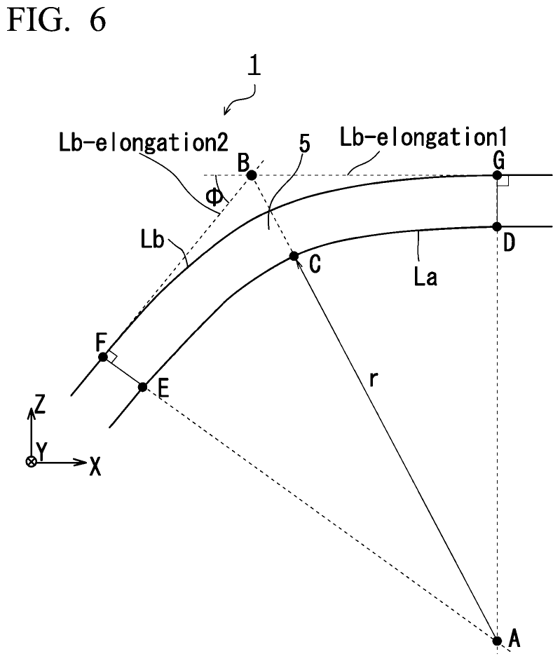

The bent portion 5 will be described in more detail with reference to FIG. 6. FIG. 6 is a diagram schematically showing an example of a bent portion (curved portion) of a grain-oriented electrical steel sheet. The bent angle of the bent portion is the angle difference occurring between the rear straight portion and the front straight portion in the bending direction at the bent portion 5 of the grain-oriented electrical steel sheet 1, and is expressed, on the outer surface of the grain-oriented electrical steel sheet 1, as an angle β that is a supplementary angle of the angle formed by two virtual lines Lb-elongation1 and Lb-elongation2 obtained by extending the straight portions that are surfaces of the planar portion 4 (4a, 4b) on both sides of the bent portion 5. In this case, the point at which the extended straight line separates from the surface of the steel sheet is the boundary between the planar portion 4 (4a, 4b) and the bent portion 5 on the outer surface of the steel sheet, which is the point F and the point G in FIG. 6.

In addition, straight lines perpendicular to the outer surface of the steel sheet extend from the point F and the point G, and intersections with the inner surface of the steel sheet are the point E and the point D. The point E and the point D are the boundaries between the planar portion 4 (4a, 4b) and the bent portion 5 on the inner surface of the steel sheet.

Here, in the present embodiment, in a side view of the grain-oriented electrical steel sheet 1, the bent portion 5 is a portion of the grain-oriented electrical steel sheet 1 surrounded by the point D, the point E, the point F, and the point G. In FIG. 6, the surface of the steel sheet between the point D and the point E, that is, the inner surface of the bent portion 5, is indicated by La, and the surface of the steel sheet between the point F and the point G, that is, the outer surface of the bent portion 5, is indicated by Lb.

In addition, FIG. 6 shows the inner radius of curvature r (hereinafter simply referred to as a radius of curvature r) of the bent portion 5 in a side view. The radius of curvature r of the bent portion 5 is obtained by approximating the above La with an arc passing through the point E and the point D. A smaller radius of curvature r indicates a sharper curvature of the curved portion of the bent portion 5, and a larger radius of curvature r indicates a gentler curvature of the curved portion of the bent portion 5.

In the wound core of the present embodiment, the radius of curvature r at each bent portion 5 of the grain-oriented electrical steel sheets 1 laminated in the sheet thickness direction may vary to some extent. This variation may be a variation due to molding accuracy, and it is conceivable that an unintended variation may occur due to handling during lamination. Such an unintended error can be minimized to about 0.2 mm or less in current general industrial production. If such a variation is large, a representative value can be obtained by measuring the curvature radii of a sufficiently large number of steel sheets and averaging them. In addition, it is conceivable to change it intentionally for some reason, but the present embodiment does not exclude such a form.

In addition, the method of measuring the inner radius of curvature r of the bent portion 5 is not particularly limited, and for example, the inner radius of curvature r can be measured by performing observation using a commercially available microscope (Nikon ECLIPSE LV150) at a magnification of 200. Specifically, the curvature center point A as shown in FIG. 6 is obtained from the observation result, and for a method of obtaining this, for example, if the intersection of the line segment EF and the line segment DG extended inward on the side opposite to the point B is defined as A, the magnitude of the inner radius of curvature r corresponds to the length of the line segment AC. Here, when the point A and the point B are connected by a straight line, the intersection on an arc DE inner the bent portion 5 is the point C.

In the present embodiment, when the radius of curvature r of the bent portion 5 is in a range of 1 mm or more and 5 mm or less and specific grain-oriented electrical steel sheets controlled so that grain boundaries with a large difference in crystal orientation between grain boundaries, which will be described below, exist at a relatively high frequency are used to form a wound core, it is possible to optimize the efficiency of the iron core according to magnetic properties. The inner radius of curvature r of the bent portion 5 is preferably 3 mm. In this case, the effects of the present embodiment are more significantly exhibited.

In addition, it is most preferable that all bent portions present in the iron core satisfy the inner radius of curvature r specified in the present embodiment. If there are bent portions that satisfy the inner radius of curvature r of the present embodiment and bent portions that do not satisfy the inner radius of curvature r in the wound core, it is desirable for at least half or more of the bent portions to satisfy the inner radius of curvature r specified in the present embodiment.

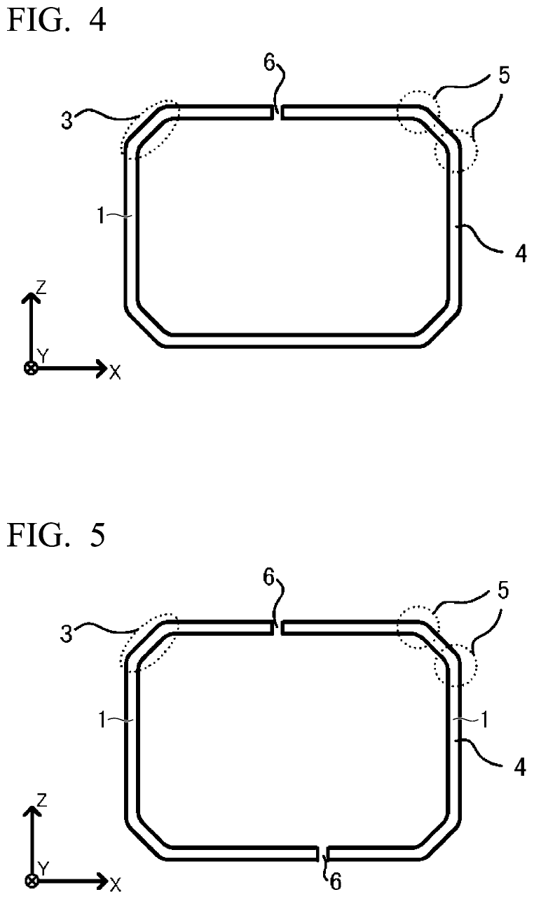

FIG. 4 and FIG. 5 are diagrams schematically showing an example of a single-layer grain-oriented electrical steel sheet 1 in the wound core main body 10. As shown in the examples of FIG. 4 and FIG. 5, the grain-oriented electrical steel sheet 1 used in the present embodiment is bent, includes the corner portion 3 including two or more bent portions 5 and the planar portion 4, and forms a substantially polygonal ring in a side view via a joining part 6 which is an end surface of one or more grain-oriented electrical steel sheets 1 in the longitudinal direction.

In the present embodiment, the entire wound core main body 10 may have a substantially polygonal laminated structure 2 in a side view. As shown in the example of FIG. 4, one grain-oriented electrical steel sheet 1 may form one layer of the wound core main body 10 via one joining part 6 (that is, one grain-oriented electrical steel sheet 1 is connected via one joining part 6 for each roll), and as shown in the example of FIG. 5, one grain-oriented electrical steel sheet 1 may form about half the circumference of the wound core, or two grain-oriented electrical steel sheets 1 may form one layer of the wound core main body 10 via two joining parts 6 (that is, two grain-oriented electrical steel sheets 1 are connected to each other via two joining parts 6 for each roll).

The sheet thickness of the grain-oriented electrical steel sheet 1 used in the present embodiment is not particularly limited, and may be appropriately selected according to applications and the like, but is generally within a range of 0.15 mm to 0.35 mm and preferably in a range of 0.18 mm to 0.23 mm.

### 2. Configuration of Grain-Oriented Electrical Steel Sheet

Next, the configuration of the grain-oriented electrical steel sheet 1 constituting the wound core main body 10 will be described. The present embodiment has features such as control of the variation in the crystal orientation in the width direction (the extension direction of the boundary line B shown in FIG. 8) of the grain-oriented electrical steel sheet 1 in the planar portion 4 (4a, 4b) adjacent to the bent portion 5 of the grain-oriented electrical steel sheets 1 laminated adjacently and the position of the controlled electrical steel sheet arranged in the iron core.

### (1) Variation in Crystal Orientation of Planar Portion Adjacent to Bent Portion

In the grain-oriented electrical steel sheet 1 constituting the wound core according to the present embodiment, in at least a part of the region in the vicinity of the bent portion 5, the crystal orientation of the laminated steel sheets 1 is controlled so that it appropriately varies in the direction (the width direction of the grain-oriented electrical steel sheet) parallel to the boundary (hereinafter referred to a bent portion boundary) between the bent portion 5 and the planar portion 4 (4a, 4b) adjacent thereto. If the variation in crystal orientation in the vicinity of the bent portion becomes small, the effect of avoiding efficiency deterioration in the iron core having an iron core shape in the present embodiment is not exhibited. In other words, when a crystal grain boundary with a large orientation change is arranged in the vicinity of the bent portion 5, this indicates that efficiency deterioration is easily minimized.

Although a mechanism by which such a phenomenon occurs is not clear, it is speculated to be as follows.

In the iron core targeted by the present embodiment, macroscopic strain (deformation) due to bending is confined within the bent portion 5 which is a very narrow region. However, when viewed as the crystal structure inside the steel sheet, the micro strain is considered to spread to the outside of the bent portion 5, that is, the planar portion 4 (4a, 4b). In particular, on the surface layer of the steel sheet on the outer side of the iron core in which tension deformation of the grain-oriented electrical steel sheet in the rolling direction becomes significant, the influence of strain into the planar portion 4 (4a, 4b) becomes wide and twin crystal deformation occurs in the region of the planar portion 4 (4a, 4b) in the vicinity of the bent portion 5. It is generally known that twin crystal deformation formed by processing significantly deteriorates the iron loss. Therefore, the number of twin crystals generated in the bent portion is reduced, and thus deterioration of the iron loss can be reduced. Here, in addition to reducing the number of twin crystals generated, in consideration of the above circumstances, minimization of expansion of the twin crystal generation area in the planar portion region 4 (4a, 4b) is also important for reducing iron loss deterioration. The generation of twin crystals is considered to be caused by crystal deformation, that is, limitation of a slip system. Therefore, it is considered that orientation dispersion of grain boundary grains in the vicinity of the bent portion 5 is very low, all components are restrained to a uniform deformation state, and the twin crystal generation area expands. On the other hand, if the orientation dispersion of grain boundary grains in the vicinity of the bent portion 5 is moderately large, the deformation operation becomes complicated, reduction of the restrained uniform deformation state is relaxed so that the deformation region, that is, the twin crystal form region, is expected. In the present embodiment, it is considered that a decrease in the iron core efficiency can be minimized by this operation. Such a mechanism of operation of the present embodiment is considered to be a special phenomenon in the iron core having a specific shape targeted by the present embodiment, and has so far hardly been considered, but can be interpreted according to the findings obtained by the inventors.

In the present embodiment, the variation in crystal orientation is measured as follows.

In the present embodiment, the following four angles α, β, γ, and φ_{3D} related to the crystal orientation observed in the grain-oriented electrical steel sheet 1 are used. Here, as will be described below, the angle α is a deviation angle from the ideal {110}<001>orientation (Goss orientation) with the rolling surface normal direction Z as the rotation axis, the angle β is a deviation angle from the ideal {110}<001>orientation with the direction perpendicular to the rolling direction (the sheet width direction) C as the rotation axis, and the angle γ is a deviation angle from the ideal {110}<001>orientation using the rolling direction L as the rotation axis.

Here, the “ideal {110}<001>orientation” is not the {110}<001>orientation when indicating the crystal orientation of a practical steel sheet, but an academic crystal orientation, {110}<001>orientation.

Generally, in the measurement of the crystal orientation of a recrystallized practical steel sheet, the crystal orientation is defined without strictly distinguishing an angle difference of about ±2.5°. In the case of conventional grain-oriented electrical steel sheets, an, angle range of about ±2.5° centered on the geometrically strict {110}<001>orientation is defined as “{110}<001>orientation.” However, in the present embodiment, it is necessary to clearly distinguish an angle difference of ±2.5° or less.

Therefore, in the present embodiment in which the {110}<001>orientation as a geometrically strict crystal orientation is defined, in order to avoid confusion with the {110}<001>orientation used in conventionally known documents and the like, “ideal {110}<001>orientation (ideal Goss orientation)” is used.
Deviation angle α: a deviation angle of the crystal orientation observed in the grain-oriented electrical steel sheet 1 from the ideal {110}<001>orientation around the rolling surface normal direction Z.
Deviation angle β: a deviation angle of the crystal orientation observed in the grain-oriented electrical steel sheet 1 from the ideal {110}<001>orientation around the direction perpendicular to the rolling direction C.
Deviation angle γ: a deviation angle of the crystal orientation observed in the grain-oriented electrical steel sheet 1 from the ideal {110}<001>orientation around the rolling direction L.

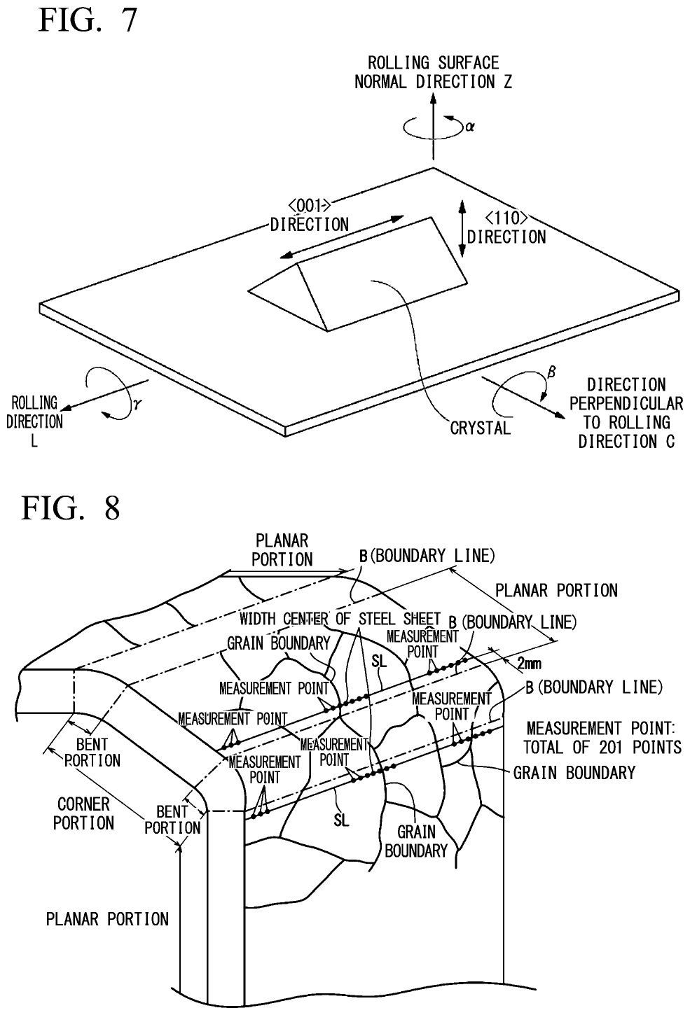

FIG. 7 shows a schematic view of the deviation angle α, the deviation angle β, and the deviation angle γ.
Angle φ_{3D}: an angle obtained by φ_{3D}=[(α₂−α₁)²+(β₂−β₁)²+(γ₂−γ₁)²]^{1/2} when the deviation angles of crystal orientation measured at two measurement points adjacent to each other on the rolling surface of the grain-oriented electrical steel sheets with an interval of 5 mm are expressed as (α₁, β₁, γ₁) and (α₂, β₂, γ₂).

The angle φ_{3D} may be described as a “spatial three-dimensional orientation difference.”

Currently, the crystal orientation of the grain-oriented electrical steel sheets practically produced is controlled so that the deviation angle between the rolling direction and the <001>direction becomes about 5° or less. This control is the same for the grain-oriented electrical steel sheet 1 according to the present embodiment. Therefore, when defining the “grain boundary” of the grain-oriented electrical steel sheet, the general definition of a grain boundary (large angle grain boundary), “boundary at which the orientation difference between adjacent regions is 15° or more” cannot be applied. For example, in a conventional grain-oriented electrical steel sheet, grain boundaries are exposed by macro etching the surface of the steel sheet, and the crystal orientation difference between both side regions of the grain boundaries is about 2 to 3° on average.

In the present embodiment, as will be described below, it is necessary to strictly define boundaries between crystals and crystals. Therefore, a method based on visual observation such as macro etching is not used as a grain boundary specification method.

In the present embodiment, in order to specify grain boundaries, measurement points are set on the rolling surface of the grain-oriented electrical steel sheet 1 at intervals of 5 mm, and the crystal orientation is measured for each measurement point. For example, the crystal orientation may be measured by an X-ray diffraction method (Laue method). The Laue method is a method of emitting an X-ray beam to a steel sheet and analyzing transmitted or reflected diffraction spots. By analyzing the diffraction spots, it is possible to identify the crystal orientation of a location to which an X-ray beam is emitted. If the emission position is changed and the diffraction spots are analyzed at a plurality of locations, the crystal orientation distribution of the emission positions can be measure. The Laue method is a technique suitable for measuring the crystal orientation of a metal structure having coarse crystal grains.

As shown in FIG. 8, in the present embodiment, within the planar portion 4 (4a, 4b) region adjacent to the bent portion 5, at a position 2 mm away in the vertical direction from a substantially straight line boundary B (bent portion boundary) that is the boundary between the bent portion 5 and the planar portion 4 (4a, 4b), a straight line SL parallel to the extension direction of the boundary B is set. Then, on the straight line SL in the planar portion 4 (4a, 4b), measurement points are arranged in a direction parallel to the boundary (line) B at intervals of 5 mm. In this case, the same numbers of measurement points are arranged on both sides of the center of the straight line SL (center of the steel sheet in the width direction) as a starting point. However, when the measurement points on both ends of the straight line SL are close to the ends of the steel sheet in the width direction, since the orientation measurement error tends to be large and data tends to be abnormal, measurement points near the ends are avoided during measurement.

Here, the reason why the distance between the position (straight line SL) of the measurement point and the boundary (line) B is set to 2 mm is that, in a region closer to the bent portion 5 than this, twin crystals are generated on the surface layer of the steel sheet, and there is concern that measurement of a desired crystal orientation variation may vary. On the other hand, this is because that, in a region further away, there is a high possibility of measuring a crystal grain orientation different from the crystal orientation of the bent portion that directly influences propagation of strain in the bent portion 5. That is, it is not always necessary to set the distance between the straight line SL and the boundary B to 2 mm. However, when the straight line SL is set at a distance exceeding 2 mm, it is necessary to consider that the setting position is within the region in which the crystal orientation that influences propagation of strain in the bent portion 5 is measured.

Then, the above deviation angle α, deviation angle β, and deviation angle γ are specified for each measurement point. Based on each deviation angle at each specified measurement point, it is determined whether there is a grain boundary between two adjacent measurement points. In the present embodiment, between two measurement points, a concept of a “grain boundary determination point” (hereinafter also referred to as a grain boundary point) which is present in the center of two measurement points and for determining whether there is a boundary (grain boundary) determined by the orientation difference between two measurement points is defined and specified.

Specifically, when the angle φ_{3D} for two adjacent measurement points satisfies φ≥1.0°, it is determined that a grain boundary is present in the center between the two points. That is, an orientation variation of less than 1.0° is negligible as an orientation variation that does not contribute to the effects of the present invention or as a mere measurement error.

It can be said that the grain boundaries with φ_{3D} of 2° or more are substantially the same as the grain boundaries of conventional secondary recrystallization grains recognized in macro etching. In general grain-oriented electrical steel sheets, since the orientation difference between two points with the grain boundary therebetween is about 2 to 30 on average as described above, a small orientation difference that is generally not recognized as a grain boundary is considered in the present embodiment. In addition, evaluation is performed taking into account the presence of grain boundaries with φ_{3D} exceeding 3°, which is not so frequent in general grain-oriented electrical steel sheets.

First, the total number of grain boundary points where φ_{3D} is measured is set as Nx, and among these, the number of grain boundary points that satisfy φ_{3D}≥1.0° is set as Nt. In the present embodiment, as described above, in the planar portion 4 (4a, 4b) region adjacent to the bent portion 5, at equal intervals in a direction parallel to the boundary line B and with respect to the position of the steel sheet in the width direction, the same numbers of measurement points are arranged on both sides using the width center of the steel sheet as a starting point. Then, a grain boundary point between two adjacent measurement points is defined, and φ_{3D} at the grain boundary point is determined. In addition, the grain boundary points are set so that Nt is 60 points or more. If Nt is less than 60 points in one steel sheet, for example, if the width of the steel sheet is narrow or if the proportion of grain boundary points with a φ_{3D} of less than 1.0° is large, measurement is performed on a plurality of steel sheets. Here, the number of grain boundary points that satisfy a φ_{3D} of 1.0° or more and less than 2.5° is set as Na, the number of grain boundary points that satisfy a φ_{3D} of 2.5° or more and less than 4.0° is set as Nb, and the number of grain boundary points with a φ_{3D} exceeding 4.0° is set as Nc. In addition, the average value of φ_{3D} of grain boundary points that satisfy φ_{3D}≥1.0° is set as φ_{3D}ave.

In the grain-oriented electrical steel sheet 1 according to the present embodiment, when grain boundaries with a large difference in crystal orientation between grain boundaries exist at a relatively high frequency, the generation of twin crystals in the vicinity of the bent portion 5 and expansion of the twin crystal generation area in the planar portion region 4 (4a, 4b) are effectively minimized. As a result, the iron core efficiency is improved.

In the wound core according to one embodiment of the present embodiment, in the planar portion 4 (4a, 4b) in the vicinity of at least one bent portion 5 of any laminated grain-oriented electrical steel sheet 1, the following formulae (1) to (4) are satisfied.

0.10≤Nt/Nx≤0.80 (1)

0.37≤Nb/Nt≤0.80 (2)

1.07≤Nb/Na≤4.00 (3)

Nb/Nc≥1.10 (4)

This expression indicates that the existence rate of grain boundaries that satisfy a φ_{3D} of 1.0° or more is limited, and in the planar portion 4 (4a, 4b) in the vicinity of the bent portion 5, grain boundaries having a large effect of minimizing the generation of twin crystals should be main components.

Formula (1) indicates that, since the interval between measurement points is 5 mm, the average interval between the grain boundaries is about 50 mm or less, that is, at least one grain boundary is present in a region of about 50 mm on average. Since the effect of the present embodiment is brought about by the presence of grain boundaries, the effect is not exhibited if the existence frequency of grain boundaries is too low. Nt/Nx is preferably 0.13 or more (about 38 mm or less as an average interval), and more preferably 0.20 or more (about 25 mm or less as an average interval). On the other hand, if the ratio is large, it means that the crystal grain size is fine, which may cause deterioration of magnetic properties so that the upper limit of Nt/Nx is 0.80 or less (about 6 mm or more as an average interval).

Formula (2) indicates that the frequency of grain boundaries with a large angle difference, which have a strong effect of minimizing twin crystals, is high. Generally, crystal orientation control in the grain-oriented electrical steel sheet increases the degree of concentration in the Goss orientation, reduces the angle difference between grain boundaries, and directs to ultimate single crystallization. Considering this, it can be said that the expression of the present embodiment in which the existence frequency of grain boundaries with a relatively large angle difference is controlled to be high is special. However, a high Nb existence frequency leads to a low degree of orientation concentration in the Goss orientation so that an excessive high frequency should be avoided. Nb/Nt is preferably 0.40 to 0.70, and more preferably 0.45 to 0.65.

Formula (3) expresses a frequency of grain boundaries with a large angle difference, which have a strong effect of minimizing twin crystals expressed by Formula (2), as a ratio to a frequency of grain boundaries with a small angle difference, which have a weak effect of minimizing twin crystals. Nb/Na is preferably 1.4 or more and more preferably 1.7 or more.

Formula (4) is an expression for avoiding formation of grain boundaries with an excessively large angle difference, which simply significantly reduce concentration in the Goss orientation, and lead to deterioration of magnetic properties. Nb/Nc is preferably 2.0 or more and more preferably 3.0 or more. In addition, it is needless to say that it is preferable to satisfy all of the above Formulae (1) to (3) in all planar portions adjacent to the bent portion present in the wound core.

As another embodiment, in the planar portion in the vicinity of at least one bent portion of any laminated grain-oriented electrical steel sheet, the following Formula (5) is additionally satisfied.

φ_{3D}ave:2.0° to 4.0° (5)

This expression is to simply evaluate the magnitude of the variation in the crystal orientation. In addition, this expression indicates an appropriate average value of the angle difference in the crystal orientation between grain boundaries in a situation in which the effects of the present embodiment are exhibited on the assumption that the above Formulae (1) to (4) are satisfied, and corresponds to one preferable aspect of the present embodiment. That is, when φ_{3D}ave is set to 2.0° to 4.0°, it is possible to sufficiently minimize the generation of twin crystals in the planar portion region. φ_{3D}ave is preferably 2.5° to 3.5°. In addition, it is needless to say that φ_{3D}ave is preferably 2.0° to 4.0° in all planar portions adjacent to the bent portion present in the wound core.

### (2) Grain-Oriented Electrical Steel Sheet

As described above, in the grain-oriented electrical steel sheet 1 used in the present embodiment, the base steel sheet is a steel sheet in which crystal grain orientations in the base steel sheet are highly concentrated in the {110}<001>orientation and has excellent magnetic properties in the rolling direction.

A known grain-oriented electrical steel sheet can be used as the base steel sheet in the present embodiment. Hereinafter, an example of a preferable base steel sheet will be described.

The base steel sheet has a chemical composition containing, in mass %, Si: 2.0% to 6.0%, with the remainder being Fe and impurities. This chemical composition allows the crystal orientation to be controlled to the Goss texture concentrated in the {110}<001>orientation and favorable magnetic properties to be secured. Other elements are not particularly limited, but in the present embodiment, in addition to Si, Fe and impurities, elements may be contained as long as the effects of the present invention are not impaired. For example, it is allowed to contain the following elements in the following ranges in place of some Fe. The ranges of the contents of representative selective elements are as follows.
C: 0 to 0.0050%,
Mn: 0 to 1.0%,
S: 0 to 0.0150%,
Se: 0 to 0.0150%,
Al: 0 to 0.0650%,
N: 0 to 0.0050%,
Cu: 0 to 0.40%,
Bi: 0 to 0.010%,
B: 0 to 0.080%,
P: 0 to 0.50%,
Ti: 0 to 0.0150%,
Sn: 0 to 0.10%,
Sb: 0 to 0.10%
Cr: 0 to 0.30%,
Ni: 0 to 1.0%,
Nb: 0 to 0.030%,
V: 0 to 0.030%,
Mo: 0 to 0.030%,
Ta: 0 to 0.030%,
W: 0 to 0.030%.

Since these selective elements may be contained depending on the purpose, there is no need to limit the lower limit value, and it is not necessary to substantially contain them. In addition, even if these selective elements are contained as impurities, the effects of the present embodiment are not impaired. In addition, since it is difficult to make the C content 0% in a practical steel sheet in production, the C content may exceed 0%. Here, impurities refer to elements that are unintentionally contained, and elements that are mixed in from raw materials such as ores, scraps, or production environments when the base steel sheet is industrially produced. The upper limit of the total content of impurities may be, for example, 5%.

The chemical component of the base steel sheet may be measured by a general analysis method for steel. For example, the chemical component of the base steel sheet may be measured using Inductively Coupled Plasma-Atomic Emission Spectrometry (ICP-AES). Specifically, for example, a 35 mm square test piece is acquired from the center position of the base steel sheet after the coating is removed, and it can be specified by performing measurement under conditions based on a previously created calibration curve using ICPS-8100 or the like (measurement device) (commercially available from Shimadzu Corporation). Here, C and S may be measured using a combustion-infrared absorption method, and N may be measured using an inert gas fusion-thermal conductivity method.

Here, the above chemical composition is the component of the grain-oriented electrical steel sheet 1 as a base steel sheet. When the grain-oriented electrical steel sheet 1 as a measurement sample has a primary coating made of an oxide or the like (a glass film and an intermediate layer), an insulation coating or the like on the surface, this coating is removed by a known method and the chemical composition is then measured.

### (3) Method of Producing Grain-Oriented Electrical Steel Sheet

The method of producing a grain-oriented electrical steel sheet is not particularly limited, and as will be described below, when production conditions are precisely controlled, it is possible to increase the frequency of crystal grain boundaries with a large orientation change. When grain-oriented electrical steel sheets having such crystal grain boundaries are used and a wound core is produced under suitable processing conditions to be described below, it is possible to obtain a wound core that can efficiently minimize deterioration of iron core efficiency. As a preferable specific example of the production method, for example, first, a slab containing 0.04 to 0.1 mass % of C, with the remainder being the chemical composition of the grain-oriented electrical steel sheet, is heated to 1,000° C. or higher and hot-rolled and then wound at 400 to 850° C. As necessary, hot-band annealing is performed. Hot-band annealing conditions are not particularly limited, and in consideration of precipitate control, the annealing temperature may be 800 to 1,200° C., and the annealing time may be 10 to 1,000 seconds. Then, a cold-rolled steel sheet is obtained by cold-rolling once, twice or more with intermediate annealing. The cold rolling rate in this case may be 80 to 99% in consideration of control of the texture. The cold-rolled steel sheet is heated, for example, in a wet hydrogen-inert gas atmosphere at 700 to 900° C., decarburized and annealed, and as necessary, subjected to nitridation annealing. The sheet passing tension and the amount of nitriding during nitridation annealing are preferably larger in consideration of precipitate control and texture control. Specifically, the sheet passing tension is preferably 3.0 (N/mm²) or more and the amount of nitriding is preferably 240 ppm or more. Then, after an annealing separator is applied to the steel sheet after annealing, finish annealing is performed at a maximum reaching temperature of 1,000° C. to 1,200° C. for 40 to 90 hours, and an insulation coating is formed at about 900° C. In addition, coating for adjusting the coefficient of friction may be then performed. Among the above conditions, particularly, the amount of nitriding and the sheet passing tension influence the variation in the crystal orientation. Therefore, when a wound core is produced, it is preferable to use a grain-oriented electrical steel sheet produced within the above condition ranges.

In addition, generally, the effects of the present embodiment can be obtained even with a steel sheet that has been subjected to a treatment called “magnetic domain control” in the steel sheet producing process by a known method.

As above, grain boundaries with a large angle difference, which is a feature of the grain-oriented electrical steel sheet 1 used in the present embodiment, can be achieved, for example, by removing some of production conditions for a known grain-oriented electrical steel sheet produced so that the degree of concentration in the Goss orientation is maximized (that is, produced so that the angle of crystal grain boundaries is minimized) from optimal conditions. Specifically, the finish annealing reaching temperature and the retention time are adjusted so that the growth of the Goss orientation to the limit is stopped, and crystal grains whose orientation is slightly deviated from the Goss orientation remain. In addition, in addition to finish annealing, the method is not particularly limited, such as the chemical composition of the slab, hot rolling conditions, decarburizing annealing conditions, nitriding conditions, and annealing separator application conditions, and when various processes and conditions are appropriately adjusted, an increase in the degree of concentration in the Goss orientation may be minimized. When the formation frequency of grain boundaries with a large angle difference in the entire steel sheet increases in this manner, even if the bent portion 5 is formed at an arbitrary position when a wound core is produced, the above formulae are expected to be satisfied in the wound core. In addition, in order to produce a wound core in which many grain boundaries with a large angle difference are arranged in the vicinity of the bent portion 5, a method of controlling the bending position of the steel sheet so that a region with a high existence frequency of grain boundaries with a large angle difference is arranged in the vicinity of the bent portion 5 is also effective. In this method, a steel sheet in which, when a steel sheet is produced, the grain growth of secondary recrystallization varies locally according to a known method such as locally changing the primary recrystallized structure, nitriding conditions, and the annealing separator application state is produced, and bending may be performed by selecting a location where the frequency of grain boundaries with a large angle difference increases.

### 3. Method of Producing Wound Core

The method of producing a wound core according to the present embodiment is not particularly limited as long as the wound core according to the present embodiment can be produced, and for example, a method according to a known wound core introduced in Patent Documents 5 to 7 in the related art may be applied. In particular, it can be said that the method using a production device UNICORE (commercially available from AEM UNICORE) (https://www.aemcores.com.au/technology/Unicore/) is optimal.

In addition, in order to increase the existence frequency of grain boundaries with a large angle difference in the vicinity of the bent portion 5, it is preferable to control conditions during core processing. For example, it can be achieved by controlling the machining rate (punch speed, mm/sec) during core processing and the amount of increase ΔT (° C.) in the steel sheet temperature due to processing heat. Specifically, the punch speed is preferably 20 to 100 (mm/sec). In addition, when the amount of increase in the steel sheet temperature due to processing heat is set as ΔT, ΔT is preferably reduced to 5.0° C. or less.

In addition, according to a known method, as necessary, a heat treatment may be performed. In addition, the obtained wound core main body 10 may be used as a wound core without change or a plurality of stacked grain-oriented electrical steel sheets 1 may be integrally fixed, as necessary, using a known fastener such as a binding band to form a wound core.

The present embodiment is not limited to the above embodiment. The above embodiment is an example, and any embodiment having substantially the same configuration as the technical idea described in the claims of the present invention and exhibiting the same operational effects is included in the technical scope of the present invention.

### EXAMPLES

Hereinafter, technical details of the present invention will be additionally described with reference to examples of the present invention. The conditions in the examples shown below are examples of conditions used for confirming the feasibility and effects of the present invention, and the present invention is not limited to these condition examples. In addition, the present invention may use various conditions without departing from the gist of the present invention as long as the object of the present invention is achieved.

### (Grain-Oriented Electrical Steel Sheet)

Using a slab having a chemical composition (mass %, the remainder other than the displayed elements is Fe) shown in Table 1 as a material, a final product (product sheet) having a chemical composition (mass %, the remainder other than the displayed elements is Fe) shown in Table 2 was produced. The width of the obtained steel sheet was 1,200 mm.

In Table 1 and Table 2, “-” means that the element was not controlled or produced with awareness of content and its content was not measured. In addition, “<0.002” and “<0.004” mean that the element was controlled and produced with awareness of content, the content was measured, but sufficient measurement values were not obtained with accuracy credibility (detection limit or less).

TABLE 1

| Steel | Slab | | | | | | | | |
|---|---|---|---|---|---|---|---|---|---|
| type | C | Si | Mn | S | Al | N | Cu | B | Nb |
| A | 0.070 | 3.26 | 0.07 | 0.025 | 0.026 | 0.008 | 0.07 | — | — |
| B | 0.070 | 3.26 | 0.07 | 0.025 | 0.026 | 0.008 | 0.07 | — | 0.007 |
| C | 0.080 | 3.45 | 0.25 | 0.025 | 0.026 | 0.008 | 0.07 | 0.0015 | — |
| D | 0.060 | 3.45 | 0.1 | 0.006 | 0.027 | 0.008 | 0.2 | — | 0.005 |

TABLE 2

| | Product sheet | | | | | | | | |
|---|---|---|---|---|---|---|---|---|---|
| Steel type | C | Si | Mn | S | A1 | N | Cu | B | Nb |
| A | 0.001 | 3.15 | 0.07 | <0.002 | <0.004 | <0.002 | 0.07 | — | — |
| B | 0.001 | 3.15 | 0.07 | <0.002 | <0.004 | <0.002 | 0.07 | — | 0.005 |
| C | 0.001 | 3.15 | 0.25 | <0.002 | <0.004 | <0.002 | 0.07 | 0.0015 | — |
| D | 0.001 | 3.34 | 0.1 | <0.002 | <0.004 | <0.002 | 0.20 | — | — |

Here, Table 3 shows details of the steel sheet producing process and conditions.

Specifically, and hot rolling, hot-band annealing, and cold rolling were performed. In a part of the cold-rolled steel sheet after decarburization annealing, a nitriding treatment (nitridation annealing) was performed in a mixed atmosphere containing hydrogen-nitrogen-ammonia.

In addition, an annealing separator in which the main component was magnesia or alumina, and its mixing ratio was changed was applied, and finish annealing was performed. An insulation coating application solution containing chromium and mainly composed of phosphate and colloidal silica was applied to a primary coating formed on the surface of the finish-annealed steel sheet, and heated to form an insulation coating. In this procedure, the degree of dispersion of crystal orientation was changed by appropriately changing the tension and nitrogen content of the steel sheet during decarburization annealing and nitridation annealing.

In this manner, steel sheets in which the variation in crystal orientation was controlled in the planar portion adjacent to the bent portion were produced. Table 3B shows details of the produced steel sheets.

TABLE 3A

| | | Hot rolling | | | | | | | |
|---|---|---|---|---|---|---|---|---|---|
| | | Heat- | Finish- | Wind- | | Hot-band | | | |
| | | ing | ing | ing | | annealing | | Cold rolling | |
| | | tem- | tem- | tem- | Sheet | Tem- | | Sheet | Cold |
| Steel | | per- | per- | per- | thick- | per- | | thick- | rolling |
| sheet | Steel | ature | ature | ature | ness | ature | Time | ness | rate |
| No. | type | ° C. | ° C. | ° C. | mm | ° C. | sec | mm | % |
| A1 | A | 1150 | 900 | 540 | 2.8 | 1100 | 180 | 0.35 | 87.5 |
| A2 | A | 1150 | 900 | 540 | 2.8 | 1100 | 180 | 0.35 | 87.5 |
| A3 | A | 1150 | 900 | 540 | 2.8 | 1100 | 180 | 0.35 | 87.5 |
| A4 | A | 1150 | 900 | 540 | 2.8 | 1100 | 180 | 0.35 | 87.5 |
| B1 | B | 1150 | 880 | 650 | 2.3 | 1150 | 180 | 0.23 | 90.0 |
| B2 | B | 1150 | 880 | 650 | 2.3 | 1150 | 180 | 0.23 | 90.0 |
| B3 | B | 1150 | 880 | 650 | 2.3 | 1150 | 180 | 0.23 | 90.0 |
| C1 | C | 1150 | 900 | 750 | 2.3 | 1100 | 120 | 0.23 | 90.0 |
| C2 | C | 1150 | 900 | 750 | 2.3 | 1100 | 120 | 0.23 | 90.0 |
| D1 | D | 1350 | 930 | 540 | 2.3 | 1050 | 180 | 0.23 | 90.0 |
| D2 | D | 1350 | 930 | 540 | 2.3 | 1050 | 180 | 0.23 | 90.0 |
| D3 | D | 1350 | 930 | 540 | 2.3 | 1050 | 180 | 0.23 | 90.0 |

TABLE 3B

| | | Decarburization | | | | | | | | |
|---|---|---|---|---|---|---|---|---|---|---|
| | | annealing | | | Nitriding | | Finish | | | |
| | | | | Sheet | Sheet | Amount | annealing | | Properties | |
| | | | | passing | passing | of | Tem- | | | Iron |
| Steel | | | | tension | tension | nitrid- | pera- | | | loss |
| sheet | Steel | Temperature | Time | N/ | N/ | ing | ture | Time | B8 | W/ |
| No. | type | ° C. | sec | mm² | mm² | ppm | ° C. | hour | T | kg |
| A1 | A | 800 | 180 | 2.5 to | 2.5 to | 190 | 1100 | 50 | 1.914 | 1.19 |
| | | | | 3.5 | 3.5 | | | | | |
| A2 | A | 800 | 180 | 3.5 to | 3.5 to | 240 | 1100 | 50 | 1.908 | 1.22 |
| | | | | 4.5 | 4.5 | | | | | |
| A3 | A | 800 | 180 | 4.5 to | 4.5 to | 250 | 1100 | 50 | 1.904 | 1.24 |
| | | | | 5.5 | 5.5 | | | | | |
| A4 | A | 800 | 180 | 5.5 to | 5.5 to | 300 | 1100 | 50 | 1.696 | 2.47 |
| | | | | 6.5 | 6.5 | | | | | |
| B1 | B | 850 | 180 | 2.5 to | 2.5 to | 190 | 1100 | 50 | 1.905 | 0.840 |
| | | | | 3.5 | 3.5 | | | | | |
| B2 | B | 850 | 180 | 4.5 to | 4.5 to | 250 | 1100 | 50 | 1.899 | 0.845 |
| | | | | 5.5 | 5.5 | | | | | |
| B3 | B | 850 | 180 | 5.5 to | 5.5 to | 300 | 1100 | 50 | 1.697 | 1.865 |
| | | | | 6.5 | 6.5 | | | | | |
| C1 | C | 850 | 180 | 2.5 to | 2.5 to | 190 | 1150 | 60 | 1.908 | 0.802 |
| | | | | 3.5 | 3.5 | | | | | |
| C2 | C | 850 | 180 | 4.5 to | 4.5 to | 250 | 1150 | 60 | 1.901 | 0.806 |
| | | | | 5.5 | 5.5 | | | | | |
| D1 | D | 840 | 180 | 2.5 to | — | — | 1100 | 70 | 1.920 | 0.838 |
| | | | | 3.5 | | | | | | |
| D2 | D | 840 | 180 | 4.5 to | — | — | 1100 | 70 | 1.906 | 0.886 |
| | | | | 5.5 | | | | | | |
| D3 | D | 840 | 180 | 5.5 to | — | — | 1100 | 70 | 1.574 | 2.845 |
| | | | | 6.5 | | | | | | |

### (Iron Core)

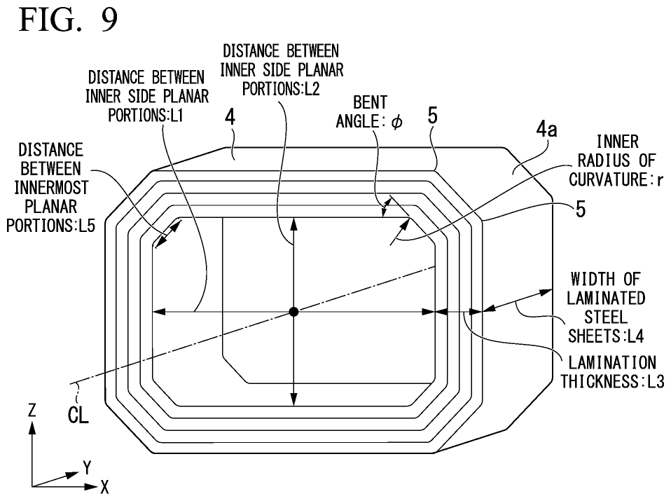

The cores Nos. a to f of the iron cores having shapes shown in Table 4 and FIG. 9 were produced using respective steel sheets as materials. Here, L1 is parallel to the X-axis direction and is a distance between parallel grain-oriented electrical steel sheets 1 on the innermost periphery of the wound core in a flat cross section including the center CL (a distance between inner side planar portions), L2 is parallel to the Z-axis direction and is a distance between parallel grain-oriented electrical steel sheets 1 on the innermost periphery of the wound core in a vertical cross section including the center CL (a distance between inner side planar portions), L3 is parallel to the X-axis direction and is a lamination thickness of the wound core in a flat cross section including the center CL (a thickness in the laminating direction), L4 is parallel to the X-axis direction and is a width of the laminated steel sheets of the wound core in a flat cross section including the center CL, and L5 is a distance between planar portions that are adjacent to each other in the innermost portion of the wound core and arranged to form a right angle together (a distance between bent portions). In other words, L5 is a length of the planar portion 4a in the longitudinal direction having the shortest length among the planar portions 4 and 4a of the grain-oriented electrical steel sheets on the innermost periphery. r is the radius of curvature (mm) of the bent portion on the inner side of the wound core, and φ is the bent angle (°) of the bent portion of the wound core. The cores Nos. a to f of the substantially rectangular iron cores have a structure in which a planar portion with an inner side planar portion distance of L1 is divided at approximately in the center of the distance L1 and two iron cores having “substantially a U-shape” are connected.

Here, the iron core of the core No. f is conventionally used as a general wound core and is a so-called trunk core type iron core produced by a method of winding a steel sheet into a cylindrical shape, then pressing the cylindrical laminated body without change so that the corner portion has a constant curvature, and forming it into substantially a rectangular shape. Therefore, the radius of curvature r (mm) of the bent portion varies greatly depending on the lamination position of the steel sheet. In Table 4, the radius of curvature r (mm) of the core No. f increases toward the outer periphery side, and is r=6 mm at the innermost periphery part and r=60 mm at the outermost periphery part (marked with “*” in Table 4).

TABLE 4

| | Core shape | | | | | | |
|---|---|---|---|---|---|---|---|
| Core | L1 | L2 | L3 | LA | L5 | r | ϕ |
| No. | mm | mm | mm | mm | mm | mm | ° |
| a | 197 | 66 | 47 | 152.4 | 4 | 1 | 45 |
| b | 197 | 66 | 47 | 152.4 | 4 | 3 | 45 |
| c | 197 | 66 | 47 | 152.4 | 4 | 5 | 45 |
| d | 197 | 66 | 47 | 152.4 | 4 | 2 | 30 |
| e | 197 | 66 | 47 | 152.4 | 4 | 6 | 45 |
| f | 197 | 66 | 47 | 152.4 | 4 | * | 90 |

### (Evaluation Method)

### (1) Magnetic Properties of Grain-Oriented Electrical Steel Sheet

The magnetic properties of the grain-oriented electrical steel sheet were measured based on a single sheet magnetic property test method (Single Sheet Tester: SST) specified in JIS C 2556: 2015.

As the magnetic properties, the magnetic flux density B8(T) of the steel sheet in the rolling direction when excited at 800 A/m and the iron loss of the steel sheet at an AC frequency of 50 Hz and an excitation magnetic flux density of 1.7 T were measured.

### (2) Iron Core Properties

Nt/Nx, Nb/Nt, Nb/Na, Nb/Nc and <pave were obtained for the steel sheets extracted from the iron core as described above. Here, the measurement was performed so that Nt was 60.

### (3) Efficiency of Iron Core

The building factor (BF) was obtained by calculating the core iron loss for the iron core formed of each steel sheet as a material and taking a ratio (core iron loss/material iron loss) with the magnetic properties of the steel sheet obtained in (1). Here, the BF is a value obtained by dividing the iron loss value of the wound core by the iron loss value of the grain-oriented electrical steel sheet which is a material of the wound core. A smaller BF indicates a lower iron loss of the wound core with respect to the material steel sheet. Here, in this example, when the BF was 1.08 or less, it was evaluated that deterioration of iron loss efficiency was minimized.

The efficiency was evaluated for various iron cores produced using various steel sheets having different crystal orientations in the planar portion adjacent to the bent portion. The results are shown in Table 5. In Table 5, the description of “-” for Nb/Nc indicates that the value was infinite (numerical value calculation was impossible) because the denominator Nc was zero. Regarding these, it was determined that Nb/Nc was sufficiently large and satisfied Formula (4). It can be understood that the efficiency of the iron core could be improved by appropriately controlling the crystal orientation when the same steel type was used. Here, the test Nos. “1-21” to “1-28” were examples of cores outside the scope of the invention in which the radius of curvature r of the bent portion was large and the influence on φ_{3D} was confirmed. It can be understood from these examples that, unless the iron core had a special shape in which the radius of curvature r of the bent portion was designed to be smaller than a specific value, even if φ_{3D} in the vicinity of the bent portion was greatly changed, a characteristic effect of improving iron core efficiency as in the present invention could not be expected.

TABLE 5A

| | | Core | | | | | | | | | | |
|---|---|---|---|---|---|---|---|---|---|---|---|---|
| | | processing | | | | | | | | | | |
| | | | Tem- | | | | | | | | | |
| | | | pera- | | | | | | | | | |
| | | | ture | | | | | | | | | |
| | | | rise | | | | | | | | | |
| | | | ΔT | | | | | | | | | |
| | | | (° C.) | | | | | | | | | |
| | | Punch | due to | | | | | | | | | |
| | Steel | speed | pro- | | Iron core properties | | | | | | | |
| Test | sheet | (mm/ | cessing | Core | Nt/ | Nb/ | Nb/ | Nb/ | | | | |
| No. | No. | sec) | heat | No. | Nx | Nt | Na | Nc | Nt | ϕave | BF | Note |
| 1-1 | A1 | 15 | 2.4 | a | 0.09 | 0.43 | 1.18 | 2.17 | 30 | 1.7 | 1.14 | Comparative |
| | | | | | | | | | | | | Example |
| 1-2 | A2 | 20 | 3.2 | a | 0.14 | 0.40 | 1.33 | 1.33 | 30 | 2.4 | 1.07 | Example of |
| | | | | | | | | | | | | invention |
| 1-3 | A3 | 100 | 2.7 | a | 0.34 | 0.80 | 4.00 | — | 30 | 3.2 | 1.01 | Example of |
| | | | | | | | | | | | | invention |
| 1-4 | A4 | 40 | 1.4 | a | 0.82 | 0.30 | 4.50 | 0.47 | 30 | 7.6 | 1.15 | Comparative |
| | | | | | | | | | | | | Example |
| 1-5 | B1 | 40 | 1.8 | a | 0.08 | 0.57 | 1.42 | 17.00 | 30 | 2.1 | 1.14 | Comparative |
| | | | | | | | | | | | | Example |
| 1-6 | B2 | 40 | 4.3 | a | 0.45 | 0.80 | 4.00 | — | 30 | 3.5 | 0.97 | Example of |
| | | | | | | | | | | | | invention |
| 1-7 | B3 | 50 | 2.6 | a | 0.71 | 0.20 | 6.00 | 0.26 | 30 | 8.8 | 1.16 | Comparative |
| | | | | | | | | | | | | Example |
| 1-8 | C1 | 50 | 4.6 | a | 0.29 | 0.20 | 0.26 | 6.00 | 30 | 1.2 | 1.15 | Comparative |
| | | | | | | | | | | | | Example |
| 1-9 | C2 | 50 | 5.0 | a | 0.39 | 0.73 | 2.75 | — | 30 | 3.2 | 0.94 | Example of |
| | | | | | | | | | | | | invention |
| 1-10 | D1 | 30 | 3.3 | a | 0.18 | 0.27 | 0.36 | — | 30 | 1.1 | 1.14 | Comparative |
| | | | | | | | | | | | | Example |
| 1-11 | D2 | 20 | 2.6 | a | 0.24 | 0.50 | 1.07 | 15.00 | 30 | 2.4 | 1.08 | Example of |
| | | | | | | | | | | | | invention |
| 1-12 | D3 | 100 | 1.6 | a | 0.52 | 0.77 | 3.83 | 23.00 | 30 | 3.5 | 0.97 | Example of |
| | | | | | | | | | | | | invention |
| 1-13 | A1 | 40 | 1.7 | b | 0.09 | 0.40 | 1.09 | 1.71 | 30 | 1.6 | 1.13 | Comparative |
| | | | | | | | | | | | | Example |
| 1-14 | A3 | 100 | 1.2 | b | 0.34 | 0.80 | 4.00 | — | 30 | 3.5 | 0.95 | Example of |
| | | | | | | | | | | | | invention |

TABLE 5B

| | | Core | | | | | | | | | | |
|---|---|---|---|---|---|---|---|---|---|---|---|---|
| | | processing | | | | | | | | | | |
| | | | Tem- | | | | | | | | | |
| | | | per- | | | | | | | | | |
| | | | ature | | | | | | | | | |
| | | | rise | | | | | | | | | |
| | | | ΔT | | | | | | | | | |
| | | | (° C.) | | | | | | | | | |
| | | | due to | | | | | | | | | |
| | | Punch | pro- | | | | | | | | | |
| | Steel | speed | cess- | | Iron core properties | | | | | | | |
| Test | sheet | (mm/ | ing | Core | Nt/ | Nb/ | Nb/ | Nb/ | | | | |
| No. | No. | sec) | heat | No. | Nx | Nt | Na | Nc | Nt | ϕave | BF | Note |
| 1-15 | B1 | 40 | 1.8 | b | 0.08 | 0.57 | 1.42 | 17.00 | 30 | 2.1 | 1.15 | Comparative |
| | | | | | | | | | | | | Example |
| 1-16 | B3 | 40 | 2.1 | b | 0.71 | 0.20 | 6.00 | 0.26 | 30 | 8.8 | 1.13 | Comparative |
| | | | | | | | | | | | | Example |
| 1-17 | C1 | 40 | 2.5 | c | 0.29 | 0.20 | 0.26 | 6.00 | 30 | 0.9 | 1.15 | Comparative |
| | | | | | | | | | | | | Example |
| 1-18 | C2 | 40 | 2.6 | c | 0.39 | 0.73 | 2.75 | — | 30 | 2.5 | 0.96 | Example of |
| | | | | | | | | | | | | invention |
| 1-19 | D1 | 30 | 3.7 | d | 0.18 | 0.27 | 0.36 | — | 30 | 1.9 | 1.14 | Comparative |
| | | | | | | | | | | | | Example |
| 1-20 | D3 | 30 | 4.2 | d | 0.52 | 0.50 | 1.07 | 15.00 | 30 | 3.3 | 1.02 | Example of |
| | | | | | | | | | | | | invention |
| 1-21 | A1 | 30 | 1.4 | e | 0.09 | 0.40 | 1.09 | 1.71 | 30 | 1.2 | 2.05 | Comparative |
| | | | | | | | | | | | | Example |
| 1-22 | A3 | 35 | 3.6 | e | 0.34 | 0.80 | 4.00 | — | 30 | 2.7 | 1.97 | Comparative |
| | | | | | | | | | | | | Example |
| 1-23 | B1 | 40 | 2.5 | e | 0.08 | 0.57 | 1.42 | 17.00 | 30 | 2.1 | 1.89 | Comparative |
| | | | | | | | | | | | | Example |
| 1-24 | B3 | 40 | 3.0 | e | 0.71 | 0.20 | 6.00 | 0.26 | 30 | 8.8 | 2.12 | Comparative |
| | | | | | | | | | | | | Example |
| 1-25 | C1 | 40 | 4.8 | f | 0.29 | 0.20 | 0.26 | 6.00 | 30 | 1.7 | 4.68 | Comparative |
| | | | | | | | | | | | | Example |
| 1-26 | C2 | 50 | 5.0 | f | 0.39 | 0.73 | 2.75 | — | 30 | 2.4 | 5.02 | Comparative |
| | | | | | | | | | | | | Example |
| 1-27 | D1 | 50 | 3.6 | f | 0.18 | 0.27 | 0.36 | — | 30 | 1.6 | 3.96 | Comparative |
| | | | | | | | | | | | | Example |
| 1-28 | D3 | 50 | 0.8 | f | 0.52 | 0.50 | 1.07 | 15.00 | 30 | 3.5 | 4.25 | Comparative |
| | | | | | | | | | | | | Example |

Based on the above results, it can be clearly understood that the wound core of the present invention satisfied the above Formulae (1) to (5) in the planar portion in the vicinity of at least one bent portion of any laminated grain-oriented electrical steel sheet and had low iron loss properties.

### INDUSTRIAL APPLICABILITY

According to the present invention, in the wound core formed by laminating bent steel sheets, it is possible to effectively minimize deterioration of iron core efficiency.

### BRIEF DESCRIPTION OF THE REFERENCE SYMBOLS

1 Grain-oriented electrical steel sheet
2 Laminated structure
3 Corner portion
4 (4a, 4b) Planar portion
5 Bent portion
6 Joining part
10 Wound core main body

1. A wound core including a substantially polygonal wound core main body in a side view,
wherein the wound core main body includes a portion in which grain-oriented electrical steel sheets in which planar portions and bent portions are alternately continuous in a longitudinal direction are stacked in a sheet thickness direction and has a substantially polygonal laminated structure in a side view,
wherein the bent portion in a side view has an inner radius of curvature r of 1 mm or more and 5 mm or less,
wherein the grain-oriented electrical steel sheets have a chemical composition containing,
in mass %,
Si: 2.0 to 7.0%, with the remainder comprising Fe and impurities, and
have a texture oriented in the Goss orientation, and
in one or more of the planar portions adjacent to at least one of the bent portions, the following formulae (1) to (4) are satisfied:
0.10≤Nt/Nx≤0.80 (1)
0.37≤Nb/Nt≤0.80 (2)
1.07≤Nb/Na≤4.00 (3)
Nb/Nc≥1.10 (4)
where, in a region of the planar portion adjacent to the bent portion, when a plurality of measurement points are arranged at intervals of 5 mm in a direction parallel to a bent portion boundary which is a boundary between the bent portion and the planar portion, Nx in Formula (1) is a total number of grain boundary determination points present in the center of two measurement points adjacent in the parallel direction and for determining whether there is a grain boundary between the two measurement points,
wherein, regarding a crystal orientation observed in the grain-oriented electrical steel sheet,
when a deviation angle from an ideal Goss orientation with a rolling surface normal direction Z as a rotation axis is defined as a,
a deviation angle from an ideal Goss orientation with a direction perpendicular to the rolling direction C as a rotation axis is defined as ρ, and
a deviation angle from an ideal Goss orientation with a rolling direction L as a rotation axis is defined as γ,
if the deviation angles of the crystal orientation measured at the two measurement points are expressed as (α₁ β₁ γ₁) and (α₂ β₂ γ₂), when a three-dimensional orientation difference of the deviation angle α, the deviation angle β, and the deviation angle γ is defined as an angle φ_{3D} obtained by the following Formula (6),
Nt in Formulae (1) and (2) is the number of grain boundary determination points that satisfy φ_{3D}≥1.00,
Na in Formula (3) is the number of grain boundary determination points that satisfy φ_{3D} of 1.0° or more and less than 2.5°,
Nb in Formulae (2) and (3) is the number of grain boundary determination points that satisfy φ_{3D} of 2.5° or more and less than 4.0°, and
Nc in Formula (4) is the number of grain boundary determination points in which φ_{3D} is 4.0° or more,
φ_{3D}=[(α₂−α₁)²+(β₂−β₁)²+(γ₂−γ₁)²]^{1/2} (6).

2. The wound core according to claim 1,
wherein, in the planar portion adjacent to at least one of the bent portions, the following Formula (5) is satisfied:
φ_{3D}ave:2.0° to 4.0 (5)
where φ_{3D}ave is an average value of φ_{3D} at grain boundary determination points that satisfy φ_{3D}≥1.0.
